(19) United States
(12) Patent Application Publication
(10) Pub. No.: US 2013/0215278 A1
(43) Pub. Date: Aug. 22, 2013

(54) Method and Apparatus for Thermal Inspection

(71) Applicant: Victor Lyashkov, Katy, TX (US)

(72) Inventor: Victor Lyashkov, Katy, TX (US)

(73) Assignee: Victor Lyashkov, Katy, TX (US)

(21) Appl. No.: 13/417,278

(22) Filed: Mar. 11, 2012

(30) Foreign Application Priority Data
Feb. 21, 2012 (RU) 2012106158

(51) Int. Cl. H04N 5/33

(52) U.S. Cl. CPC H04N 5/33
USPC 348/164

(57) ABSTRACT

A method and apparatus for rapid finding of the hidden defects/heterogeneity under protective layer and for a qualitative evaluation of thickness and heterogeneity of the protective layer itself. Disclosed method is based on creation of conditions of rapid heat exchange and identifying defects via reading changes of thermodynamic profile of inspecting object.

### RELATED APPLICATIONS

Not Applicable.

### STATEMENT REGARDING FEDERALLY SPONSORED RESEARCH OR DEVELOPMENT

Not Applicable.

### PATENTS CITED

U.S. Pat. No. 6,236,049 B1 Robert L. Thomas D. Favro et all (May 22, 2001)

U.S. Pat. No. 7,507,965 B2 T Randall Lane, Jerry Schlagheck (Mar. 24, 2009)

### BACKGROUND OF THE INVENTION

1. Field of the Invention

The present invention is directed to a method and apparatus for rapid qualitative identification of hidden defects, heterogeneity of built material, and thickness of the protective layer itself on inspected objects from small to large sizes.

2. Description of the Prior Art

Infrared cameras used in multiple technical areas for inspection of sports of heat “leaks”, direct remote measurements of temperature in technological processes, medicine, and more.

It is known method and apparatus from U.S. Pat. No. 7,507,965 B2 which uses direct remote measurement by IR cameras of thermal profile of object with identification of some heterogeneity. However this method cannot be used under slow changing temperature conditions due to inability to read isotherms, representing the same temperature lines. This method does not also provide ability to identify deepness of defect if so. Limitations stipulated by static nature of measurements without additional sources of heat and cold flow, and also not taking in considerations thermodynamic characteristics of object's built materials.

It is also known method and apparatus from U.S. Pat. No. 6,236,049 B1 to identify defects/cracks in material with ultrasonic oscillator used as for external energy source. Oscillated energy will be dissipated in damaged/cracked locations of inspected object, indicating problematic locations with cracks. Method and apparatus designed to identify cracks but not heterogeneity, cannot be used over large and massive objects due to impractically massive size of ultrasonic oscillator needs. In addition, ultrasonic oscillator is complex device and has been rarely used as the source of energy, so full effect on human health is unknown and may be have significant effect.

All known disclosed inspection methods and apparatuses used to measure thermal profile of inspected objects without consideration of thermodynamic parameters of built materials of the object. It leads to inaccurate results in identification of hidden defects, their deepness, heterogeneity, and absolute value. In the present invention, the method and apparatus are free of listed disadvantages.

### BRIEF SUMMARY OF THE INVENTION

The present invention is directed to the method and apparatus employing of infrared camera in identification of hidden defects or heterogeneity, and use of additional sources of cold flow and hot flow while measuring temperature profile of object real time.

The present invention utilizes a measurements of dynamic thermal profiles, changing over time, in different thermodynamic regimes, where thermodynamic properties of object-built materials are carefully considered for qualitative measurement of the deepness of hidden defect, heterogeneity, and thickness of the protective layer which are always depend on built material's thermal conductivity, thermal capacity, and thermal inertia.

In cases of extremely slow heat exchange such as convective heat exchange by object with hidden defects, no defects or heterogeneity will be visible in thermal profile of object due to poorly-edged visible isotherms.

In cases of rapid heat exchange between tested object and surrounding air, the reading isotherms will appear very contritely, helping in accurate evaluation of heterogeneity, hidden defect, and thickness of protective layer.

### DESCRIPTION OF THE DRAWINGS

FIG. 1 is a view of a temperature profile of object without defect;

FIG. 2 is a view of a temperature profile of object with defect;

FIG. 3 is an inspecting object with defect before applying of the protective layer/filler;

FIG. 4 is an inspecting object with defect after hiding defect with protective layer/filler;

FIG. 5 is a view of inspecting object's thermal profile after 20 min of slow/convective cool-down of the present invention;

FIG. 6 is a view of inspecting object's thermal profile after 40 sec of rapid cool-down of the present invention.

FIG. 7 is a color view of inspecting object's thermal profile after 20 min of slow/convective cool-down of the present invention;

FIG. 8 is a color view of inspecting object's thermal profile after 40 sec of rapid cool-down of the present invention.

### DETAILED DESCRIPTION OF INVENTION

The present invention of method and apparatus employs of infrared camera in identification of hidden defects and heterogeneity for measurements of dynamic thermal profiles, changing over time under different thermodynamic regimes.

Thermodynamic properties of object-built materials are carefully considered for accurate measurement of the accurate evaluation of the size of hidden defect/heterogeneity.

It is known that volumetric heat capacity I is a function of k, ρ, c:

I=\sqrt{kρc}

Where:

k—material heat conductivity, p—material density, c—material heat capacity.

In this invention, the method and apparatus utilize effect of significant differences of heat capacity and conductivity in widely used constructive materials displayed in table below for evaluation of the heterogeneity under protective layer:

| Heat Conductivity | Watt/m * K | Heat Capacity | kJ/(kg * K) |
|---|---|---|---|
| Aluminum | 230.000 | Aluminum | 0.930 |
| Asbestos | 0.150 | Asbestos | 0.800 |
| Copper | 380.000 | Copper | 0.385 |
| PVC plastic | 0.190 | PVC plastic | 1.000 |
| Steel | 52.000 | Steel | 0.444 |
| Fiber glass | 0.036 | Fiber glass | 0.840 |

Unlike to other methods and apparatuses, this invention utilizes measurements of dynamic thermal profiles of inspecting object changing over time depends on intensity of heat exchange between the surface of protective layer and surrounding media such as air. Instead of use an infrared camera to measure static thermal profiles, measurement of dynamic thermal profiles provides better accuracy in evaluation of the thickness of protective layer and hidden defects.

It was confirmed in series of experiments that if tested object will exchange the heat from its surface with different intensity, thermal images of the same object will vary depend on 3 thermodynamic characteristics of protective layer and hidden defect: thermal conductivity, thermal capacity, and thermal inertia as a result of thermal capacity, or all listed. Importantly to understand that heat exchange process happens between protective layer and defect as well as between protective layer and air. Heat transfer from defect to air will depend of: nature/material of protective layer, thickness of protective layer, intensity of heat exchange driven by primarily temperature differences between any 2 points—inside and outside of the object.

All thermodynamic processes will last as long as difference in temperature will exist in the object, between the object and surrounding the object media such as air. Processes will reach state of thermodynamic equilibrium when temperatures will be equalized (inside and outside of the object through the protective layer).

In cases when objects are under extremely slow heat exchange conditions, no variations in surface thermal profile will be visible by infrared cameras because of whole object's surface represents same temperature at any point (large and uniform isotherm). Due to small heat capacity and while slow cool-down, a thin protective layer will “work” as good thermal conductor because of speed “supplying internally” heat from defect to protective layer will be higher than speed of heat exchange from protective layer to the air. In this case effect of thin protective layer can be neglected due to its minimal heat capacity, and so—minimal effect on whole thermodynamic process. Thermal inertia, which is “producing” heat from the deep layers and hidden defects (from inside), will keep thermodynamic process very slow and steady till state of thermodynamic equilibrium will be achieved.

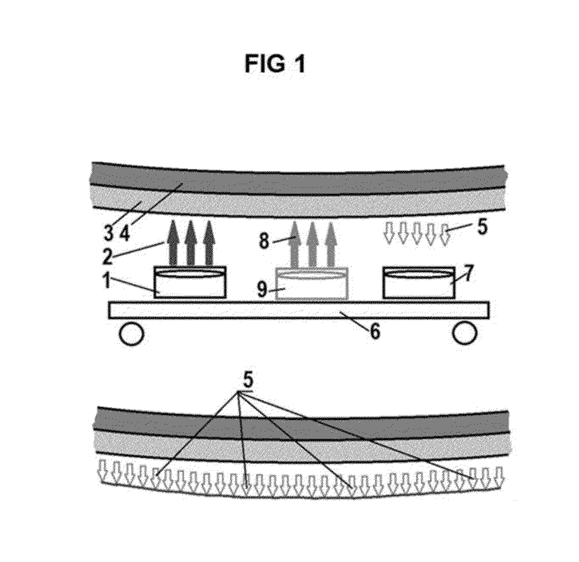

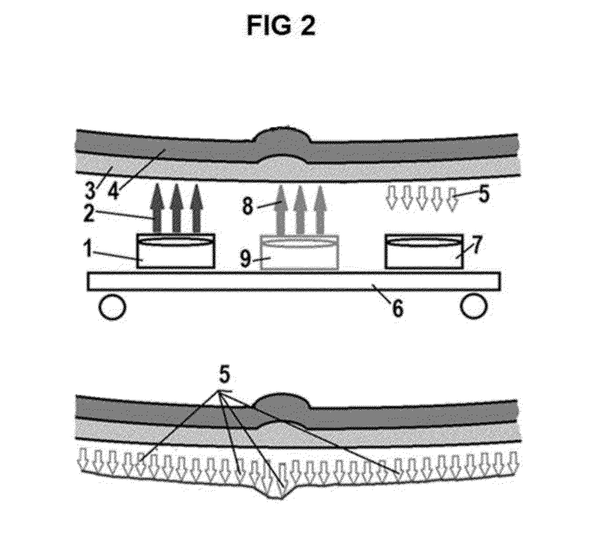

Unlike to slow-steady heat exchanges, in cases of rapid heat exchange between the surface of tested object and cooling rapidly air, isotherms of thermal profile have discovered to be very contrast in locations of hidden defects, helping in evaluation of existence of the hidden defect or heterogeneity, and evaluation of thickness of the protective layer itself and uneven base object profile irregularity. To create conditions of rapid heat exchange additional cooler 9 (FIGS. 1, 2) required in system. For the cases when temperature of the object has little or no difference to the temperature of the surrounding air, additional heater 1 (FIGS. 1, 2) requires in system.

Use of additional heater 1 (FIGS. 1, 2) helps to “magnify” temperature differentials where it is required. In this invention any efficient direct radiation energy source can be used such as heater with fan and different lamps. Only few seconds required to expose protective layer with the heat radiation following further rapid cool-down to get isotherms with sufficient contrast for identification of problematic locations. Isotherms will indicate uneven thickness and thermal heterogeneity of inspecting object caused by heterogeneity in density and other characteristics, affecting thermodynamic processes of built materials.

Longer exposure of protective layer 3 (FIGS. 1, 2) with heat will lead to deeper heat penetration into heterogeneity, defect, and even basement material 4 (FIG. 2). In general, higher temperature difference between inspecting object and cooling air provides better reading results and more accurate evaluation of defects. Thus greater cool-down time will improve results for deep defects and heterogeneity giving more accurate reading of thermal profile. However at same time, lesser contrast will be read on small defects in protective layer itself 3 (FIG. 2) due to small thermal capacity and thermal inertia values.

The accuracy of measurements largely depends on infrared camera sensitivity and resolution, differences of thermal capacity and thermal conductivity between protective layer 3 and base material 4 (FIGS. 1, 2), exposure time of tested object, intensity of heat exchange, and air conditions. Most of modern infrared cameras with resolution of 50 mK are satisfactory for such type of inspection.

Quality of isotherm will vary widely depend on initial temperatures of the object and air before measurements, resolution, settings and sensitivity of infrared camera 7, intensity and exposure time by object of heat 2 from the heat source 1, intensity and exposure time by object of cold flow 8 from cooler 9, thickness of protective layer 3, difference in heat capacity and heat conductivity of protective layer 3 vs. base material 4 (FIG. 2).

Procedure of Use Disclosed Method

Process starts from measurement of average temperature of an object and an air where inspecting object is. If temperature difference is less than 3° C. then use of heater 1 (FIGS. 1, 2) is required. In common, to standardize and simplify measuring procedure, use of heat source 1 (FIGS. 1, 2) is highly recommended.

Rapid cool-down required to make sure that only protective layer 3 (FIG. 2) is mainly involved in thermodynamic process. Otherwise results of reading hidden defects in thin layer will be unreliable, or even not achievable.

Following rapid heating (FIG. 2), operator with infrared camera 7 begins taking images of temperature profile for inspected object 3. Due to convective cool-down, surface temperature 3 will start to decrease and infrared camera 7 will register changes of isotherms 5 radiated by the surface 3.

In cases of even and homogeny surface layer 3 the dynamic temperature profile 5 will be also very even (FIG. 1).

In cases of uneven or heterogenic protective layer 3 (FIG. 2) and hidden defects, temperature profile 5 will be changed in time unevenly due to different thermal capacity and thermal inertia.

If isotherms 5 FIG. 2 are not displaying sharply on IR camera 7 then a cooler 9 with a cold flow 8 is required in addition. Use of cooler makes process time efficient vs. convective cool-down. Intensiveness of cold flow 8 (FIG. 2) can vary depend on protective layer material 3 properties, its thickness, initial conditions etc. Source of cold flow 9 accelerates inspecting process and makes isotherms “sharper” (FIG. 2).

Heater 1, cooler 9, and infrared camera 7 are placed on moving cart (FIGS. 1, 2). Distances between heater, cooler, and infrared camera are adjustable (FIGS. 1, 2). Speed of moving cart is defined by thermodynamic properties of protective layer materials 3 and base material 4, intensity of heat and cold flow, and sensitivity of infrared camera.

### Description of Experimental Results

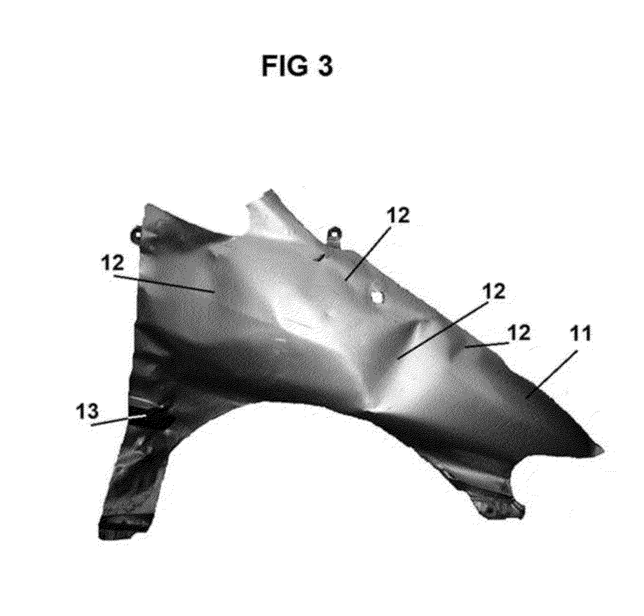

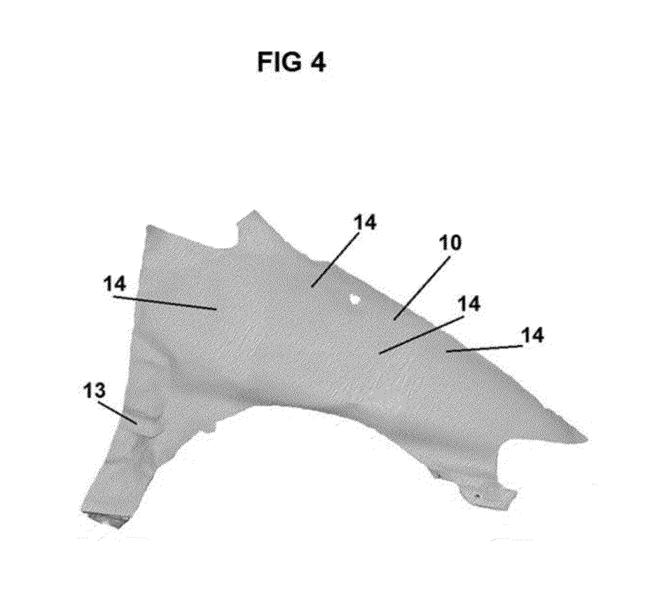

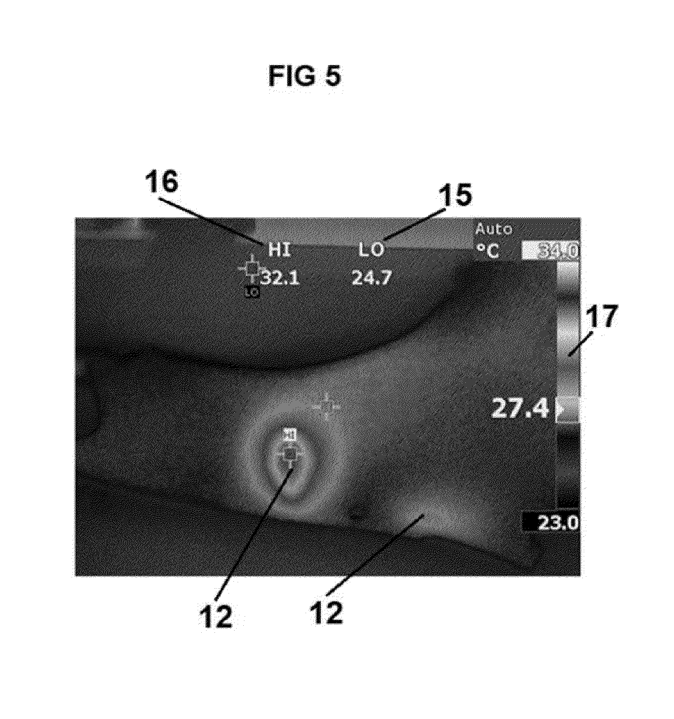

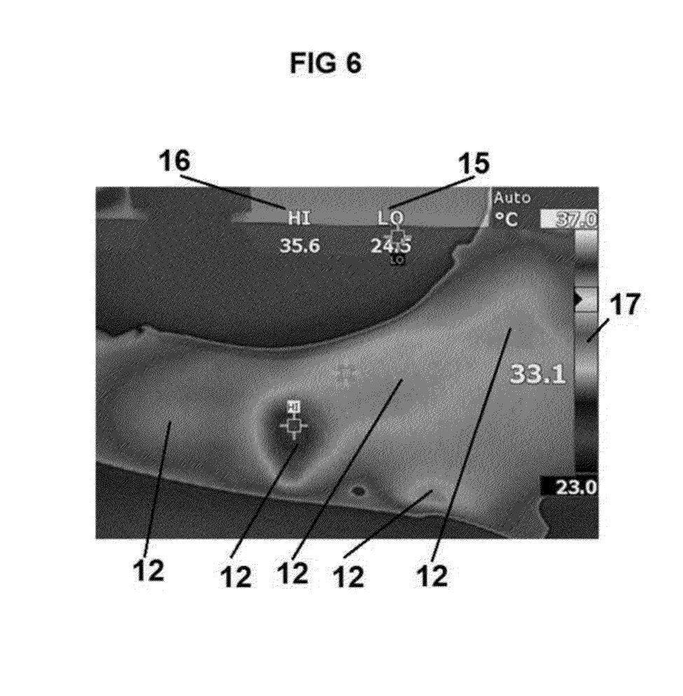

In order to confirm if the disclose method achievable, and to determine optimal combination of initial conditions, infrared camera requirements, optimal speed of moving cart, and more multiple experiments were performed with satisfactory results on a part 11 (FIG. 3) of a car body after accident. A part of car body was originally shaped by manufacturer piece of low carbon steel of 0.8 mm thick 4 (FIG. 1, FIG. 2). After car accident deformed locations 12 (FIG. 3) were filled with body repair filler and hided with primer and paint 3 (FIG. 2) to make it look like non-defect car body part. Locations 14 (FIG. 4) represent intentionally hidden defects on car body part. FIG. 5 and FIG. 6 represent use of disclosed method for rapid identification of hidden defects under reconstructed layers of primer and paint on medium size object 11 (FIG. 3). Infrared cameras with grey scale have limited capacity to demonstrate ability in identification of hidden defects. It is highly recommended to use color-screen infrared cameras with best possible resolution of sensor and graphical display both. Examples of color representation of graphical information are on FIG. 7 and FIG. 8 where descriptive numbers are in full compliance of FIG. 5 and FIG. 6 accordingly. On FIG. 5, FIG. 6, FIG 7, FIG. 8 item 17 represents temperature scale selected for thermal inspection, item 15 represents absolute value of lowest temperature spot (available on some models of infrared cameras), and item 16 represents absolute value of highest temperature spot (available on some models of infrared cameras).

What is claimed is:

1. A method and apparatus for rapid thermal inspection, comprising: a. evaluation of initial state of inspecting object before inspection by direct measurement with infrared camera its average temperatures and surrounding air; b. rapid cool-down of inspecting section within short time by efficient cooler to create a larger temperature differentials for finding hidden defects with evident isotherms reading on infrared camera; c. synchronized slow-steady moving infrared camera following a heater and a cooler for reading thermodynamic profile of the inspected object.

2. Prior inspection surface heating with any source of heat if less than 3° C. temperature differential is between inspecting object and surrounding media of claim 1;

3. Heater, cooler, and infrared camera of claim 1 located on adjustable cart with ability to change distance between named tools for better reading of thermodynamic profile of stationary object.

4. Heater, cooler, and infrared camera of claim 1, located stationary but reading of thermodynamic profile of inspecting object which is moving across the named tools.
